(19) United States
(12) Patent Application Publication
(10) Pub. No.: US 2011/0230988 A1
(43) Pub. Date: Sep. 22, 2011

(54) BUTTON SHAPED PORTABLE MEDIA PLAYER WITH INDICIA

(75) Inventor: Nicholas E. Dangerfield, New York, NY (US)

(73) Assignee: Parte LLC, New York, NY (US)

(21) Appl. No.: 13/033,366

(22) Filed: Feb. 23, 2011

Related U.S. Application Data
(60) Provisional application No. 61/315,610, filed on Mar. 19, 2010.
(60) Provisional application No. 61/432,983, filed on Jan. 14, 2011.

(51) Int. Cl. G06F 17/00

(52) U.S. Cl. 700/94

(57) ABSTRACT

In one embodiment of the present invention, a portable media player has the form of a wearable button and includes a body that has a front face and a rear face. The media player also has a means for detachably attaching the body to an article of clothing, such as a shirt or jacket. The player has a memory that contains at least one audio file and also includes means for converting the audio file into an analogue sound signal, wherein the content of the memory is factory programmed and cannot be changed by the user. Playback controls are provided to permit playing of the audio file stored in memory. In accordance with the present invention, artist indicia are fixedly disposed on the front face of the body. The indicia correspond to the content of the audio file. For example, the indicia can include the name of the artist and/or the name of the song and/or contain graphics that are associated with the artist of the audio file content.

### CROSS REFERENCE TO RELATED APPLICATION

The present application claims the benefit of U.S. patent application Ser. No. 61/315,610, filed Mar. 19, 2010 and U.S. patent application Ser. No. 61/432,983, filed Jan. 14, 2011 which are hereby incorporated by reference in their entireties.

### TECHNICAL FIELD

The present invention relates to portable media players and in particular, to a portable media player that has a button shape and includes indicia that directly relates to content stored in the media player.

### BACKGROUND

Over the years, portable audio or media players have become increasingly more popular and are some of the more commonly owned electronic consumer products. Portable players are used in any number of different settings. For example, many people use portable players while exercising, e.g., outdoors or in the gym, and many use the players while commuting or walking between locations.

Generally, a portable audio player is a personal mobile device that allows the user to listen to recorded audio while mobile. A personal player refers to a portable audio player that is listened to with headphones. Many times, these players also can receive broadcast radio signals, such as AM and FM signals.

One of the first portable players that enjoyed widespread success was a compact cassette player, such as the Sony Walkman introduced in 1979. As technology advanced, different types of portable players became popular and mainstream. For example, compact disc players that played commercial CDs enjoyed success and the later models were able to play recordable CDR and CDRW media. The next breakthrough in technology resulted in digital audio players becoming available. The players were based on flash memory or hard disk storage. Files were usually compressed using lossy compression; this reduces file size at the cost of some loss of quality. The advantage of solid-state digital audio players over hard disks and CDs is resistance to vibration, small size and weight, and low battery usage.

Digital audio players are designed so that a user can download content into the memory of the player. The audio content of the player is therefore dynamic and can be easily changed by the user by simply deleting files that the user is no longer interested in and/or downloading new files. The player typically includes a display screen, such as an LED screen, which displays certain information, such as the track number, the name and/or selection being played, radio station, etc.

These type of players are thus of a type that the consumer has access rights and where the content storage is dynamic and can be changed by the end user. The players can be worn on the body by using a strap, belt or the like.

Nonprogrammable (closed) players can also come in different forms, such as an electronic greeting card. The card will typically play a song, such as Happy Birthday, when the consumer opens the card. The card has a micro speaker, a coil cell and simple leaf switch that opens and closes the circuit based on the opening and closing of the greeting card itself. However, this type of device is not intended to be worn and function as a media player for the listening pleasure of an end user.

### SUMMARY

In one embodiment of the present invention, a portable media player has the form of a wearable button and includes a body that has a front face and a rear face. The media player also has a means for detachably attaching the body to an article of clothing, such as a shirt or jacket. The player has a memory that contains at least one audio file and also includes means for converting the audio file into an analogue sound signal, wherein the content of the memory cannot be changed by the user. In other words, the memory is a factory programmed memory and the player of the present invention does not have a data port to allow the user to write to the memory. Playback controls are provided to permit playing of the audio file stored in memory. In accordance with the present invention, artist indicia are fixedly disposed on the front face of the body. The indicia correspond to the content of the audio file. For example, the indicia can include the name of the artist and/or the name of the song and/or contain graphics that are associated with the artist of the audio file content.

These and other aspects, features and advantages shall be apparent from the accompanying Drawings and description of certain embodiments of the invention.

### BRIEF DESCRIPTION OF THE DRAWINGS

FIG. 1 is a perspective view of a button shaped portable media player with indicia according to one exemplary embodiment of the present invention;

FIG. 2 is front elevation view of the player of FIG. 1;

FIG. 3 is a rear elevation view of the player of FIG. 1;

FIG. 4 is a side elevation view of the player of FIG. 1;

FIG. 5 is a cross-sectional view of the player of FIG. 1;

FIG. 6 is a rear and bottom perspective view of a button shaped portable media player with indicia according to another embodiment;

FIG. 7 is a front elevation view of the button shaped portable media player of FIG. 6; and

FIG. 8 is a rear elevation of the button shaped portable media player of FIG. 6.

### DETAILED DESCRIPTION OF CERTAIN EMBODIMENTS OF THE INVENTION

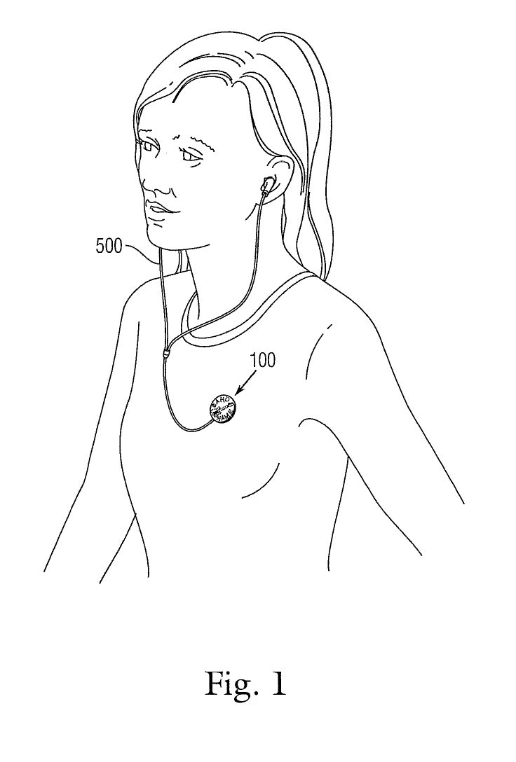

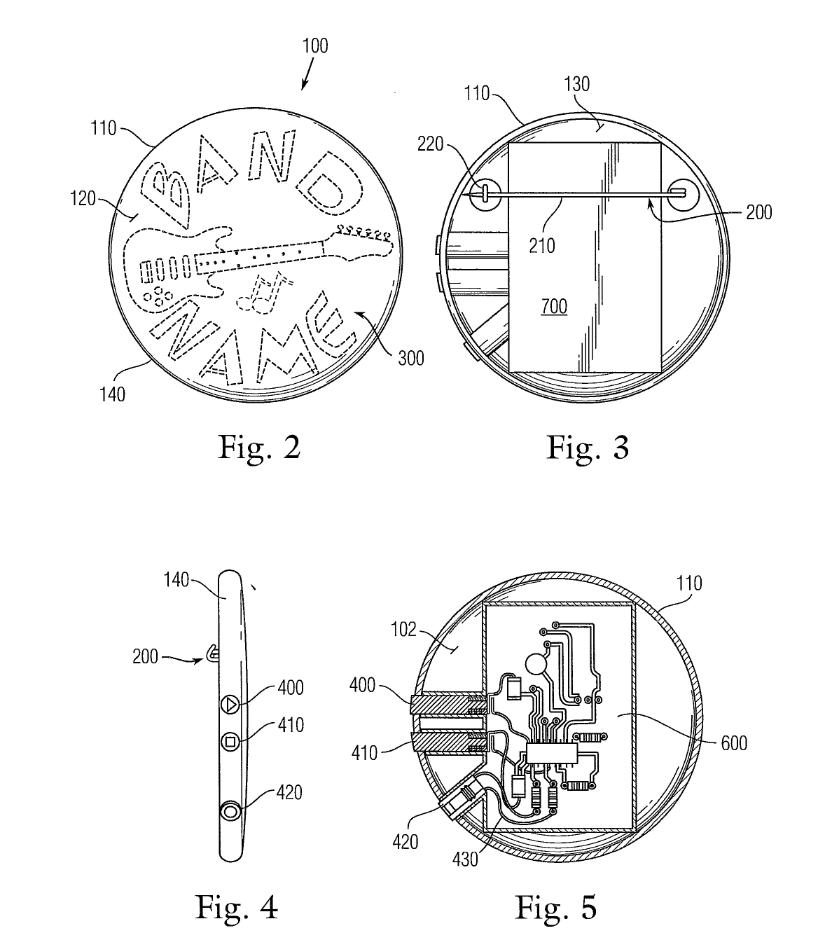

In accordance with a first embodiment of the present invention, a portable media player 100 is illustrated in FIGS. 1-5. The portable media player 100 is in the form of a wearable button and includes a button body 110 having a front face or surface 120 and an opposite rear face or surface 130. The button body 110 has a peripheral side wall 140 that extends between the front and rear surfaces 120, 130.

While in the illustrated embodiment, the body 110 has a circular shape, it will be understood that the body 110 can have other shape, such as a shape selected from the group consisting of a square, a rectangle, a triangle, and an oval.

The button shaped media player 100 is intended to be worn on a body of a user similar to how a conventional button is worn. More specifically, the player 100 includes a means 200 to allow the player 100 to be worn on the user's body. The means 200 can be any number of different types of conventional coupling techniques (mechanical fastening) to detachably attach the player 100. The embodiment shown in FIGS. 1-4 uses a pinback structure 200 as the means for attaching the button body 110 to an article of clothing worn by the user. The pinback structure 200 is disposed along the rear surface 130 and includes a depressable pin 210 that engages and locks with a pin clasp 220 to securely attach the button body 110 to the clothing. In an unlocked position, the pin 210 is free of the pin clasp 220 and this allows the pin 210 to be inserted through the article of clothing and then engaged with the pin clasp 220 to securely attach the button.

It will be appreciated that a pinback structure is only one type of structure for attaching a button to clothing. Other clasp or clamp or other structures are equally possible for removably attaching the button player 100 to the article of clothing.

In accordance with the present invention, the front face 120 includes indicia 300 that corresponds to the content that is stored in memory. In other words, the indicia 300 is artist indicia that is representative of the song(s) stored in memory. For example, the indicia 300 can be a graphic representation of at least one or more of the following: the name of the artist, the song title, an album cover, or other indicia that is representative of the content stored in memory.

In one embodiment, only a single song is stored in memory of the player 100 and the indicia 300 lists the artist name and/or song title and/or contains a graphical image that is representative thereof.

It will be appreciated that the indicia 300 on the front face 120 is thus fixed (static) just as is the stored content in memory is fixed and cannot be changed by the end user.

As a result and in accordance with one embodiment of the present invention, the indicia 300 can be in the form of a lenticular image that is disposed across the surface of the front of the player.

The players of the present invention have widespread use and can be provided to consumers (end users) through a wide array of different channels. For example, the player 100 can therefore serve as a promotional item for promoting an artist's song or a selection of songs by an artist. The player 100 can also be used to promote an event or venue as well as well as be used at a charity or similar event. The recipient or consumer can simply attach the player 100 to the article of clothing and then actuate the player to allow listening of the content thereof.

The size of the player 100 can vary depending upon the application; however, the player 100 should be of a size that can be comfortable worn on the user's article of clothing and due to the relatively simply electronics, described below, that are contained within the player 100, the player 100 can have a relatively small size, such as a size slightly bigger than a quarter. However, it can have a larger size if more space is needed to place the desired indicia 300 on the front face 120.

Since there is no dynamic display, the indicia 300 is limited to representing the content stored in memory and the content cannot be manipulated in any manner. The user can only simply play the media and stop the playing of the media at any point in time. In other words, the consumer has no access right (since there are no data ports or the like) and instead, the memory is factory programmed. In one embodiment, the memory can be of a WORM type (write once, read many), which refers to data storage media that can be written to once, but read multiple times. It will be appreciated that other types of memory can be used so long as the end user does not have access rights to the memory and thus cannot alter the content of the memory.

In one embodiment, the memory storage is large enough to be able to contain a CD quality type of audio (e.g., 700 MB or more).

As a result, since the player 100 is a closed media player in that there is no consumer access right, the player 100 includes only limited playback controls. For example, the player 100 can include a first button 400 (play button) and a second button 410 (stop button). The first and second buttons 400, 410 are disposed along the peripheral side wall 140 of the body 110.

To play the content, the user simply presses the first button 400 and to stop the play, the user simply presses the second button 410. The electronics of the player 400 can be configured so that the player 400 is powered on by pressing the play button 400 and to power off, the user can hold down the stop button 410 for a prescribed period of time (as opposed to merely pressing the stop button once to stop play).

In terms of playback volume, the player 100 can be designed so that there is only one preselected playback volume and thus, there is no need for any volume controls. Alternatively, the playback controls can include volume control buttons (+ and − buttons) that can be located along the peripheral side wall 140. For ease of illustration, the present figures show the first embodiment where the volume is set at a prescribed setting and cannot be changed by the user.

To allow listening of the content through headphones 500, the player 100 includes a headphone jack 420 (audio port) that is disposed within the body 110 of the player 100. The jack 420 is thus open along the peripheral side wall 140 of the body 110 and is configured to receive a plug of the headphones 500. The headphones 500 are conventional headphones that are configured to be worn with portable media players. The jack 420 can also receive a plug that is connected to one or more speakers to permit listening of the content by means of the speakers.

FIG. 5 is a cross-sectional view of the player 100 taken through the body 110 to illustrate the inner components of the player 100. For example, the player 100 includes an inner compartment or cavity 102 that contains electronics that allow storage and controlled play of media content (e.g., a song or selection of songs that is saved as compressed audio files).

The player 100 is similar to most MP3 players and includes a memory storage device (e.g., flash memory or a miniature hard disk drive), an embedded processor, and a microchip (audio codec chip) to cover the compressed audio file into an analogue sound signal.

The electronics thus generally include a processor 600 (microchip) that has memory (e.g., internal flash memory (solid-state memory)) for storing the media and is electrically connected to the first and second buttons 400, 410 and the jack 420. For example, electrical leads or contacts 430 connect the buttons 400, 410 and the jack 420 to the processor 600 to allow the limited control of the player as described herein. A power source (not shown) is likewise included within the inner compartment 102. The power source is electrically connected to the processor 600 and can be in the form of one or more batteries (e.g., rechargeable batteries or non-rechargeable batteries).

It will be appreciated that other conventional components found in media players can be included as part of the electronics. For simplicity, the processor 600 is understood to include conventional electronic components that process the stored media to allow for playback, e.g., a digital signal processor (DSP), amplifier, etc.

Once again, the player 100 is not an open, fully writable device and therefore it does not include a data port to allow content to be uploaded and/or downloaded externally from a device, such as a personal computer, to the memory. As described previously, the content stored in memory is static and at the time of manufacturing the chip (processor 600), the content is stored in memory to allow subsequent assembling and sealing of the player 100.

As can be seen in FIG. 3, a cover 700 or the like can be included as part of the rear face 130 of the body 110. For example, the cover 700 can be located underneath the movable pin of the pinback structure 200. The cover 700 can be fastened to the body 110 using conventional means, such as a snap-fit.

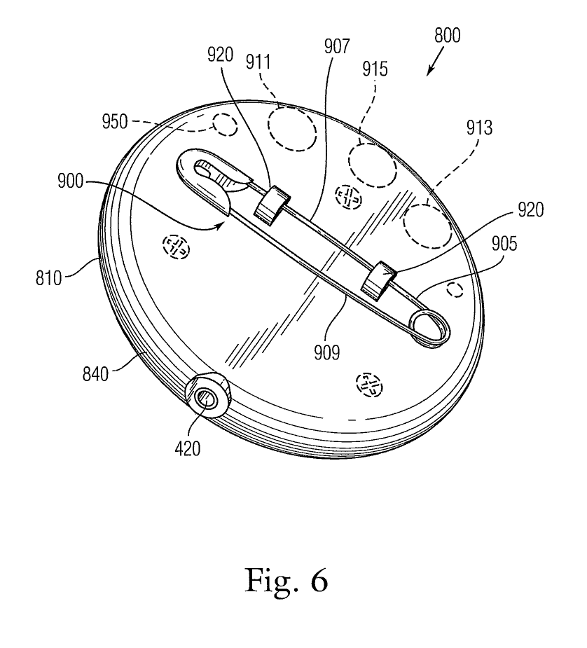

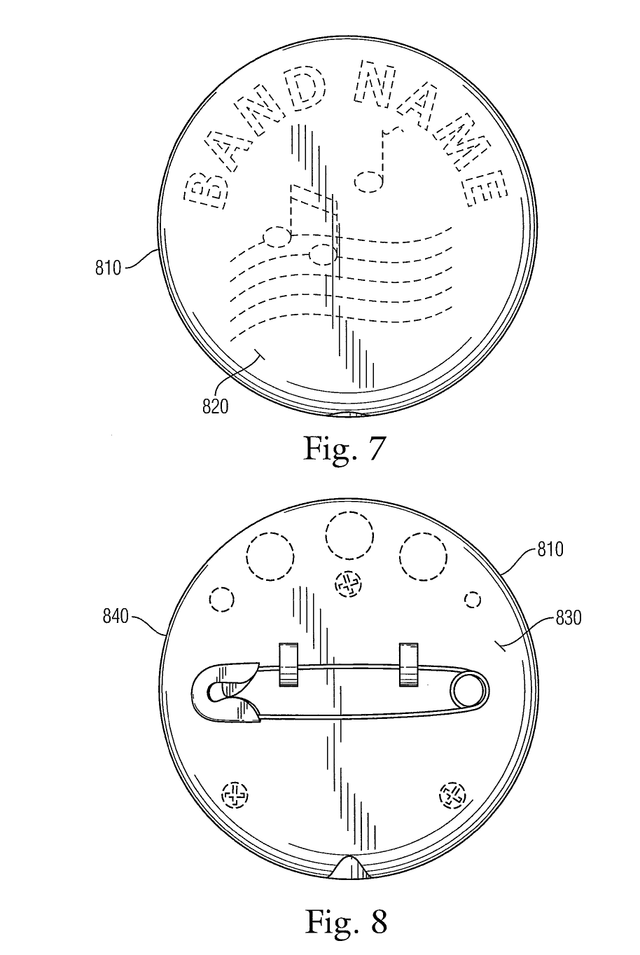

Now referring to FIGS. 6-8, a portable media player 800 according to another embodiment is illustrated. The portable media player 800 is similar to the button 100 as will be appreciated by viewing the figures. As described herein, the portable media player 800 is intended to operate in a similar manner as the button 100. In other words, the portable media player 800 is in the form of a wearable button and includes a button body 810 having a front face or surface 820 and an opposite rear face or surface 830. The button body 810 has a peripheral side wall 840 that extends between the front and rear surfaces 820, 830.

While in the illustrated embodiment, the body 810 has a circular shape, it will be understood that the body 810 can have other shape, such as a shape selected from the group consisting of a square, a rectangle, a triangle, and an oval.

The button shaped media player 800 is intended to be worn on a body of a user similar to how a conventional button is worn. More specifically, the player 800 includes a means 900 to allow the player 800 to be worn on the user's body. The means 900 can be any number of different types of conventional coupling techniques (mechanical fastening) to detachably attach the player 800. The embodiment shown in FIGS. 6 and 8 uses a pin 905 as the means for attaching the button body 810 to an article of clothing worn by the user. The pin 905 can be any number of different types of pins including a safety pin as shown in the figures. Unlike the first embodiment, the pin 905 used in the player 900 of the second embodiment is actually a separate component and can be of a conventional safety pin construction.

One will appreciate that since the pin 905 can be a separate component relative to the other parts and relative to the portable media player 900, different types of pins 905 can be selected for use with a common media player 900 design. For example, the pins 905 can be provided in any number of different colors and can include different graphic patterns and can even come in different sizes. This allows the user to customize the player 900 according to his or his tastes since different versions of the media player can be offered to consumers (end users).

Any number of different techniques can be used to secure the pin 905 to the body 810. In the illustrated embodiment, a crimping technique is employed in which the pin 905 is inserted between a pair of crimpable members 920 that are spaced apart from one another. The members 920 can be in the form of crimpable prongs, protrusions or the like that are attached at one end to the body 810. The members 920 thus extend outwardly from the body 810 and have free ends that are not attached to the body 810. Also shown in the figures, the members 920 have curved shapes to provide a gap there underneath to permit reception of the pin 905. The members 920 can thus be formed during a die cutting process when the body 810 itself is formed.

The pin 905 is thus secured after the fabrication of the body 810 and the other components. To secure the pin 905 to the body 810, the pin 905 is inserted underneath the prongs 920 so that the fixed bar 907 (the pin part that does not pivot open) is located underneath the prongs 920. The prongs 920 are then crimped or otherwise bent so as to completely capture and secure the pin 905 in place. The flexible bar 909 of the pin 905 is thus free of containment by the prongs 920 and thus can pivot open to allow the pin 905 to be fastened to an article of clothing that is being worn by the user.

The portable media player 900 also includes a number of other features that are not disclosed with respect to the media player 100.

For example, one such optional feature is an “instant play” feature in which the electronics (processor) of the player 900 can be configured such that once a plug is received into the jack 420, the player 900 is automatically powered on and starts playing content. This auto or instant play feature eliminates the need for the user to press a “play” button in a control panel to power up the unit. Since the portable media player is intended to be a “playbutton” in that it includes fixed content as described herein, the player 900 can have very basic controls, such a volume up and down, rewind and fast forward. Of course, if the user does not want to listen to the content right after inserting the plug into the jack 420, the user can simply press the stop button. It will also be appreciated that the processor of the present invention can be configured to provide an “instant off” feature in which the player 900 is turned off when the plug (connector) is removed from the jack 420.

It will also be appreciated that the jack 420 of the body 810 not only allows headphones 500 to be used but also allows a connector cable or the like (not shown) to be used to permit other functions, such as connecting to a USB port of a computer for charging of the batteries, connecting to speakers, etc.

As with the first embodiment, the media player 900 includes a number of control buttons, including a rewind (skip back) button 911, a fast forward (skip forward) 913 and a play/stop (pause) button 915. A reset button 919 can also be provided.

The media player 900 can also optionally include an equalizer (EQ) which can be activated with a button 950. As is known, equalization is the process of adjusting the strength of certain frequencies within a signal. The circuit or equipment used to achieve equalization is called an equalizer. These devices strengthen (boost) or weaken (cut) the energy of specific frequency bands. Media players typically have equalizers that boost bass or treble frequencies. The user can simply press the EQ button 950 to activate the equalizer and the user can be provided with a plurality of set equalizer modes that can be accessed by simply pressing the button 950 to scroll through the available EQ options. When the user hears a mode that is pleasing to the ear, the user can simply stop pressing the button 950 and leave the unit on this setting. The processor can be configured such that the equalizer is shut off by holding the button 950 down for a set time and similarly, the equalizer can be turned on by pressing down the button 950.

To reduce the number of buttons that are used, the player 900 is constructed such that the volume and fast forward and rewind features share the same buttons and in particular and for example, the fast forward (skid ahead) button can serve as either the volume up or down button and similarly, the rewind (skip back) button can serve as the opposite volume up or down. To change the volume, the user simply holds one of these buttons down for a period of time, while to operate the fast forward or rewind functionality, the user simply presses the button quickly.

The stop button also functions as a pause button.

Yet another feature that can be provided is a diffused light feature in which a light, such as an LED, is present within the body 810 and when the player 800 is operated, the light turns on. The light (LED) can serve several different purposes, first it can simply alert the user that the unit is on. Secondly, the light can provide diffused light that can be purposely combined with the indicia on the front of the body 810 to provide a certain appearance to the unit. For example, the graphic indicia that is part of the front can include a section where backlighting provides a dramatic effect and in such case, the light is placed within the body 810 at such location. For example, the graphic indicia may include a body of water and in which case, the light, which can be a blue LED, can be positioned behind this portion of the indicia and therefore, the body of water can have a blue glow when the player is operated. Similarly, certain text can strategically have backlighting. For example, the light can be positioned so that it backlights the name of the band and/or the name of the album, etc. Of course, the light can be positioned and designed to simply provide diffuse lighting which backlights the entire or most of the graphic indicia.

It will therefore be appreciated that the front cover of the body 810 can be formed of a translucent or semi-translucent material to permit such light to emanate therethrough. Accordingly, while the back of the unit may be formed of metal, the front portion of the unit is preferably formed of plastic or the like to permit the desired lighting.

The present invention thus provides a portable media player (MP3) that has no end user access. In other words, the end consumer (end user) cannot access or alter the content that is provided on the media player. The portable media player of the present invention thus provides the end user the feeling that he or she is listening to a conventional LP or CD. In addition, since the front of the media player is designed to display indicia that relates to the content of the media player, the end user can make others aware of what he or she is listening to since the media player is prominently worn on an article of clothing of the end user and is therefore visible to others.

In one alternative embodiment, the jack 420 can be used by a content supplier (e.g., music company, etc.) to upload content to the player; however, as described below, the media player is sealed to the end user in that the end user has no ability to modify the stored content. In other words, the basic components of the media player can be manufactured and then supplied to a content provider with the memory being blank. The memory that is provided to the content supplier is thus of a WORM type (write once, read many). The content supplier then uploads content to the memory, as by accessing the memory through the jack 420; however, once the memory is written with the content, it cannot be altered in any way by the end user since the content supplier has written the memory once and therefore, the memory cannot be altered. In other words, the memory is capable of storing information just once (by action of the content supplier).

In this embodiment, once the content supplier uploads content to the portable media player, the content supplier can then package the media player for distribution to the end user using conventional distribution avenues. The content supplier is thus an intermediary actor in the entire manufacturing and distribution chain.

While the invention has been described in connection with certain embodiments thereof, the invention is capable of being practiced in other forms and using other materials and structures. Accordingly, the invention is defined by the recitations in the claims appended hereto and equivalents thereof.

What is claimed is:

1. A media player comprising:
a body having a button shape, the body having a front face and a rear face;
a means for detachably attaching the body to an article of clothing, the means being disposed along the rear face of the body;
a processor including memory that contains at least one audio file, wherein the memory is factory programmed and therefore the content of the memory cannot be changed by an end user;
playback controls to permit playing of the audio file stored in memory and permit the play of the audio file to be stopped; and
artist indicia fixedly disposed on the front face, the indicia corresponding to the artist of the content stored in the audio file.

2. The media player of claim 1, wherein the button shaped body has a circular shape.

3. The media player of claim 1, wherein the means for detachably attaching the body to the article of clothing comprises a pinback structure.

4. The media player of claim 1, wherein the playback controls includes a play button that when actuated causes play of the audio file and a stop button that when actuated causes the audio file to stop playing.

5. The media player of claim 1, wherein the artist indicia includes at least one of a name of the artist, a song title and a graphic cover associated with either the song or a collection that contains the song.

6. The media player of claim 1, wherein the artist indicia includes at least one of text and graphics.

7. The media player of claim 1, wherein the playback controls are located along a peripheral side edge that is located between the front face and the rear face.

8. The media player of claim 1, wherein the body further includes a headphone jack to permit headphones to be worn to listen to the playback of the audio file.

9. The media player of claim 8, wherein the headphone jack is located along a peripheral side edge that is located between the front face and the rear face.

10. The media player of claim 1, wherein the memory includes at least two different audio files containing music of a single artist.

11. The media player of claim 1, wherein the audio file includes music of an artist.

12. The media player of claim 1, further including a power source.

13. The media player of claim 1, wherein the player is free of any data ports that permit a file to be saved to the memory or deleted from the memory.

14. The media player of claim 1, wherein the body has a shape selected from the group consisting of a square, a rectangle, a triangle, and an oval.

15. A portable media player in the form of a wearable button comprising:
a body having a button shape, the body having a front face and a rear face;
a means for detachably attaching the body to an article of clothing;
a memory that contains at least one audio file;
means for converting the audio file into an analogue sound signal, wherein the content of the memory cannot be changed by an end user;
playback controls to permit playing of the audio file stored in memory; and
artist indicia fixedly disposed on the front face, the indicia corresponding to the content of the audio file.

16. The media player of claim 15, wherein the body is free of any data port that allows the end user to change the content of the memory.

17. A portable media player in the form of a wearable button comprising:
a body having a button shape, the body having a front face and a rear face;
a means for detachably attaching the body to an article of clothing, wherein the means comprises a separate safety pin that is captured by crimping members associated with the body but can be opened to allow the pin to extend through the article of clothing for attaching the body to the clothing;
a processor and memory that contains at least one audio file;
a jack formed in the body for receiving a connector, the jack being electronically connected to the processor;
playback controls to permit playing of the audio file stored in memory; and
indicia fixedly disposed on the front face, the indicia corresponding to the content of the audio file.

18. The media player of claim 17, wherein the crimping members comprise curved prongs attached at first ends to the body, wherein in an initial position before crimping, a gap is formed below the prongs that partially receives the safety pin and in a crimped position, the safety pin is captured underneath the prongs.

19. The media player of claim 18, wherein the crimping members are die cut members.

20. The media player of claim 17, wherein the processor is configured such that when the connector is received within the jack, the audio file is automatically played.

21. The media player of claim 17, further including a light that is disposed within the body, the front face of the body being fanned of a material that is either translucent or transparent at least in an area proximate the light to permit light to be seen when viewing the front face.

22. The media player of claim 17, wherein the indicia comprises a static image.

23. The media player of claim 22, wherein the indicia comprises a lenticular image.

24. The media player of claim 17, wherein the safety pin includes a fixed bar and a pivotable bar that moves between open and closed positions, the fixed bar being captured underneath the crimping members.
